(19) United States
(12) Patent Application Publication
(10) Pub. No.: US 2025/0021371 A1
(43) Pub. Date: Jan. 16, 2025

(54) METHOD AND SYSTEM FOR MANAGING KUBERNETES CLUSTER RESOURCES IN A MULTI-CLOUD ENVIRONMENT

(71) Applicant: FOUNDATION OF SOONGSIL UNIVERSITY-INDUSTRY COOPERATION, Seoul (KR)

(72) Inventors: Young Han KIM, Seoul (KR); Ji Hye YUN, Seoul (KR)

(21) Appl. No.: 18/432,381

(22) Filed: Feb. 5, 2024

(30) Foreign Application Priority Data
Jul. 11, 2023 (KR) 10-2023-0089647

(51) Int. Cl. G06F 9/455; G06F 9/54

(52) U.S. Cl. CPC G06F 9/45558; G06F 2009/4557; G06F 9/541

(57) ABSTRACT

A method for managing Kubernetes cluster resources in a multi-cloud environment includes: (a) selecting, when a workload which is impossible to distribute due to lack of resources is detected in a logical cloud including a plurality of clusters which are present in multiple clouds, one or more first workloads to be migrated from a first cluster to another cluster by referring to a predetermined policy, and a workload intent set for workloads executed in the logical cloud; (b) selecting a second cluster to which the one or more first workloads are to be migrated; (c) migrating the one or more first workloads to the second cluster, and deleting the one or more first workloads from the first cluster; and (d) distributing the workload which is impossible to distribute to the first cluster.

### CROSS-REFERENCE TO RELATED APPLICATION

This application claims priority under 35 U.S.C. § 119(a) to Korean Patent Application No. 10-2023-0089647 filed in the Korean Intellectual Property Office on Jul. 11, 2023, the entire contents of which are incorporated herein by reference.

### BACKGROUND

### (a) Technical Field

The present disclosure relates to a method and a system for managing Kubernetes cluster resources in a multi-cloud environment.

### (b) Background Art

Kubernetes (k8s) is an open source container orchestration platform that automates a number of manual processes that are accompanied by distributing, managing and expanding containerized applications.

When a system is operated based on the Kubernetes, a situation occurs in which scale out is required due to lack of resources of a worker node.

In the applications, there are clusters which can be distributed according to features and clusters which cannot be distributed.

Here, a Kubernetes cluster is an environment that manages a service executed in the form of a container.

When there is no resource in a cluster which an application which should be particularly executed, the cluster should be scaled out.

However, the resource of the cluster may be limited according to a feature and a use environment, and there is a case where it is impossible to scale out the cluster.

Therefore, in a multi-cloud environment, when the cluster is not possible to be scaled out in a specific cloud, some workloads in the corresponding cluster should be migrated to other clouds to create a resource space.

However, in order to migrate some of the workloads being executed, a new selection criterion is required and the selected workload must be migrated without interruption.

In the related art, there is no method which can perform migration by considering a state of the workload which is being executed.

### SUMMARY OF THE DISCLOSURE

In order to solve the problem in the related art, it is an object of the present disclosure to provide a method and a system for managing Kubernetes cluster resources in a multi-cloud environment, which can secure a required resource space when all resources of a cluster in which application distribution is requested are exhausted and scale-out of the cluster is impossible.

In order to achieve the object, according to an embodiment of the present disclosure, provided is a method for managing Kubernetes cluster resources in a multi-cloud environment, which includes: (a) selecting, when a workload which is impossible to distribute due to lack of resources is detected in a logical cloud including a plurality of clusters which is present in multiple clouds, one or more first workloads to be migrated from a first cluster to another cluster by referring to a predetermined policy, and a workload intent set for workloads executed in the logical cloud; (b) selecting a second cluster to which one or more first workloads are to be migrated; (c) migrating the one or more first workloads to the second cluster, and deleting one or more first workloads from the first cluster; and (d) distributing the workload which is impossible to distribute to the first cluster.

The method may further include: before step (a) above, configuring one or more logical clouds including the plurality of clusters through a management cluster; and monitoring a resource of each of the plurality of clusters through a cluster API.

Step (a) above may include invoking, by an application scheduler, a migration controller when the workload which is impossible to distribute is detected; selecting, by the migration controller, one or more first workloads to be migrated to another cluster by referring to the policy and the workload intent; and selecting, by a placement controller, a second cluster to which one or more first workloads are to be migrated according to the invoking by the application scheduler.

The cluster API may store information on whether node scaling is possible in each of the plurality of clusters.

The method may include: before step (a) above, selecting a cluster X set in which resources remain and a cluster Y set in which there is no resource, but the node scaling is possible among a plurality of clusters designated as a distribution target of the workload; and trying the distribution of the workload in order from the cluster X set to the cluster Y set.

Steps (a) to (d) above may be performed when the workload distribution is unsuccessful in both the cluster X set and the cluster Y set.

When there is a scale-out request of an application which is being currently executed, steps (a) to (d) above may be performed when resources of the cluster receiving the scale-out request are insufficient, and node scaling in the cluster receiving the scale-out request is impossible.

The workload intent may include whether it is possible to migrate each workload and priority information.

The policy may include a plurality of criteria for rescheduling in the logical cloud and reflection rankings of the plurality of respective criteria.

The plurality of criteria may include a priority defined in the workload intent, an inter-service connectivity, and a CPU utilization.

The first cluster and the second cluster may be included in different clouds.

Step (c) above may include, between the migrating of one or more first workloads to the second cluster and the deleting of one or more first workloads from the first cluster, changing an IP (Internet Protocol) address mapped with a URL (Uniform Resource Locator) of an initial service to an IP address of a service which is present in the second cluster in a name server; and transmitting traffic input from a first Istio ingress gateway included in the first cloud to a second Istio ingress gateway included in the second cloud.

According to another aspect of the present disclosure, provided is a system for managing a cluster resource in multiple clouds, which includes: an application scheduler detecting a workload which is impossible to distribute due to lack of resources in a logical cloud including a plurality of clusters which are present in the multiple clouds; a migration controller selecting one or more first workloads to be migrated to another cluster from a first cluster by referring to a predetermined policy, and a workload intent set for workloads which are executed in the logical cloud by the invoking by the application scheduler; a placement controller selecting a second cluster to which one or more first workloads are to be migrated according to the invoking by the application scheduler; and a resource synchronizer migrating one or more first workloads to the second cluster by referring to AppContext in which information on one or more first workloads and the second cluster is updated, deleting the one or more first workloads from the first cluster, and distributing the workload which is impossible to distribute to the first cluster after one or more first workloads are deleted.

According to yet another aspect of the present disclosure, provided is an apparatus for managing a cluster resource in multiple clouds, which includes: a processor; and a memory connected to the processor, in which the memory stores program instructions executed by the processor to select, when a workload which is impossible to distribute due to lack of resources is detected in a logical cloud including a plurality of clusters which is present in multiple clouds, one or more first workloads to be migrated from a first cluster to another cluster by referring to a predetermined policy, and a workload intent set for workloads executed in the logical cloud, select a second cluster to which one or more first workloads are to be migrated, migrate one or more first workloads to the second cluster, delete one or more first workloads from the first cluster, and distribute the workload which is impossible to distribute to the first cluster after one or more first workloads are deleted.

According to the present disclosure, there is an advantage in that some of workloads which are being executed can be migrated without service interruption through predetermined policy and workload intent.

### BRIEF DESCRIPTION OF THE DRAWINGS

FIG. 1 is a diagram illustrating a framework for managing Kubernetes cluster resources in a multi-cloud environment according to an embodiment of the disclosure.

FIG. 2 is a diagram schematically illustrating a node scaling scheme of each of cost/delay type according to an embodiment of the disclosure.

FIG. 3 is a diagram illustrating a node scaling process for a workload which is requested to be newly distributed according to an embodiment of the disclosure.

FIG. 4 is a diagram illustrating a processing process of a scale-out request of a workload in the related art.

FIG. 5A to 5B are a flowchart illustrating a workload redistribution procedure according to an embodiment of the disclosure.

FIG. 6 is a diagram illustrating a service migration process using an Istio ingress gateway.

### DETAILED DESCRIPTION

The present disclosure may be embodied in various modifications and have various embodiments, so specific embodiments will be illustrated in the drawings and described in detail in the detailed description. However, this does not limit the present disclosure to specific exemplary embodiments, and it should be understood that the present disclosure covers all the modifications, equivalents and replacements included within the idea and technical scope of the present disclosure.

The terms used in the present specification are used only to describe specific embodiments, and are not intended to limit the present disclosure. A singular form includes a plural form unless the context clearly dictates otherwise. In this specification, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In addition, the components of the embodiment described with reference to each drawing are not limitedly applied only to the corresponding embodiment, and may be implemented to be included in another embodiment within the scope of maintaining the technical idea of the present disclosure, and further, even if a separate explanation is omitted, it is natural that a plurality of embodiments may also be re-implemented as one integrated embodiment.

In addition, in the description with reference to the accompanying drawings, the same components are assigned the same or related reference numerals regardless of the reference numerals, and redundant descriptions thereof will be omitted. In describing the present disclosure, a detailed description of related known technologies will be omitted if it is determined that they unnecessarily make the gist of the present disclosure unclear.

The present disclosure provides a method for securing a required resource space when all resources of a cluster in which workload (application) distribution is requested are exhausted and scale-out of the cluster is impossible in a multi-cloud environment.

In an embodiment of the disclosure, a method for selecting some workloads suitable for migration among workloads which are being executed is provided, and in this case, information on a current state of the workload may be included in a selection criterion, and a method for what factors should be considered or what is preferred is provided.

In addition, a procedure is provided, which allows the selected workload to be executed in other clouds without service interruption.

A system according to an embodiment of the disclosure is assumed as an environment in which the cluster is operated based on Kubernetes on multi-clouds.

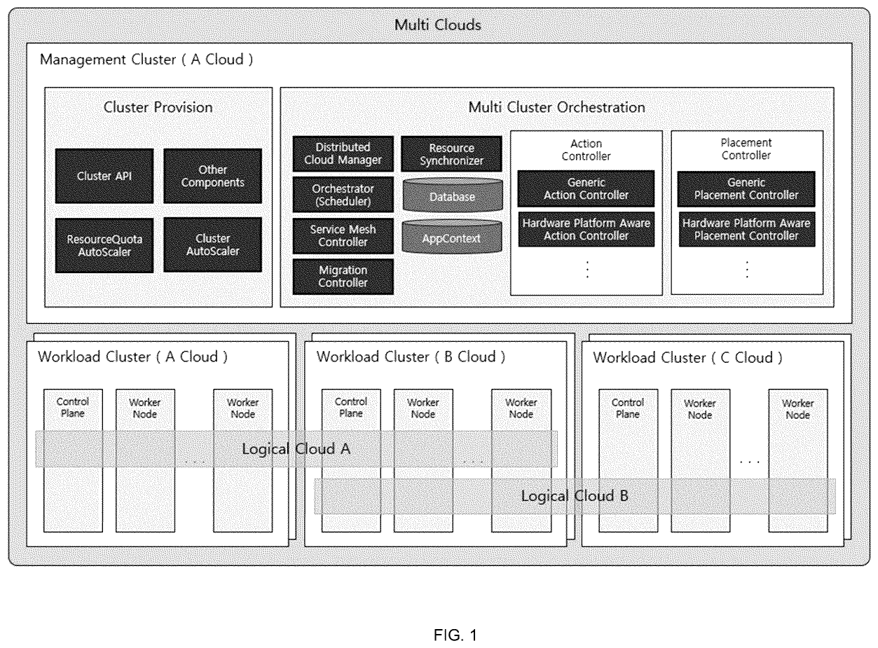

FIG. 1 is a diagram illustrating a framework for managing Kubernetes cluster resources in a multi-cloud environment according to an embodiment of the disclosure.

FIG. 1 is a diagram illustrating a management cluster of a main Cloud A and a workload cluster on multi-clouds which a user primarily uses in a multi-cloud environment.

According to an embodiment of the disclosure, the management cluster is constructed in an arbitrary cloud (Cloud A) which the user primarily uses to integrally manage all clusters.

A plurality of clusters which exist on multiple clouds are bound to constitute a logical cloud (e.g., Logical cloud A or Logical cloud B) through the management cluster, and a workload distribution strategy is established in the logical cloud.

According to an embodiment of the disclosure, the management cluster may include an application scheduler, a migration controller, a placement controller, and a resource synchronizer.

When a workload which is impossible to distribute is detected in the logical cloud including the plurality of clusters which exist on the multiple clouds through the configuration, a process of selecting one or more first workloads to be migrated from a first cluster to another cluster by referring to a predetermined policy and a workload intent set for the workloads executed in the logical cloud, selecting a second cluster which is to migrate one or more first workloads, migrating the one or more first workloads to the second cluster, and deleting the one or more first workloads from the first cluster is performed.

This will be described below in detail again.

Further, it may be described that the workload redistribution process is performed by an apparatus including a processor and a memory.

Here, the processor may include a central processing unit (CPU) capable of executing a computer program or other virtual machines.

The memory may include a non-volatile storage device such as a fixed hard drive or a removable storage device. The removable storage device may include a compact flash unit, a USB (Universal Serial Bus) memory stick, etc. The memory may also include a volatile memory such as various random access memories.

The memory according to an embodiment of the disclosure stores program instructions for selecting a workload to be migrated, and migrating and deleting the selected workload when the workload which is impossible to distribute is detected.

According to an embodiment of the disclosure, when a common cluster exists in cloud A, the corresponding cluster is also jointly configured as the logical cloud, and is used as necessary.

Here, the common cluster means a cluster which may be shared and used by clusters in the same cloud while being present in cloud A.

The common cluster is a cluster which may be used before scaling out to another cluster, and as a result, a latency may be reduced compared to the workload in another cloud.

According to an embodiment of the disclosure, each cluster may be defined as the cost/delay type.

The cost type is a type which prioritizes the cost, and the delay type is a type which minimizes the delay.

A node scaling scheme of each cluster depends on the type defined in the cluster.

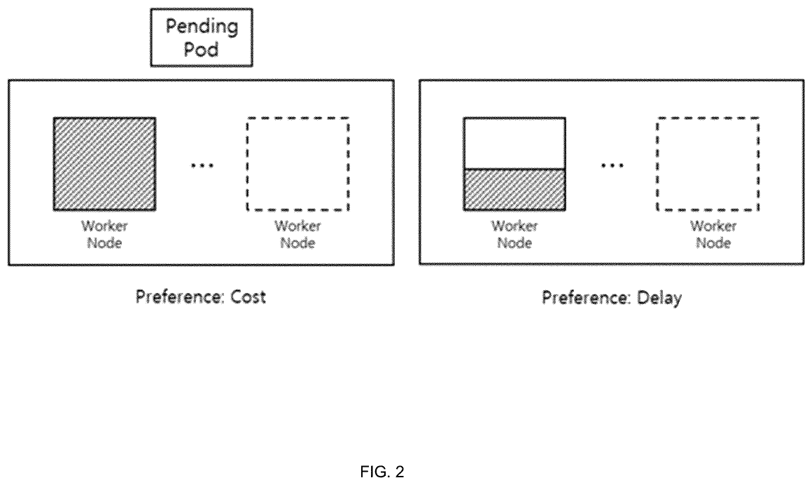

FIG. 2 is a diagram schematically illustrating a node scaling scheme of each of cost/delay type according to an embodiment of the disclosure.

As illustrated in FIG. 2, in the case of the cost type, the cluster is initially constructed only by a control plane, and when the workload becomes a pending state by using all actual resources, a node is scaled out.

Meanwhile, in the case of the delay type, the cluster is initially constructed by the control plane and a minimum worker node, and the node is scaled out in advance before using all resources.

According to an embodiment of the disclosure, a cluster API (Application Programming Interface) monitors the cloud resource in order to prevent a node fail from occurring in a node scaling process, and displays whether node scaling is possible in the clusters which are present in the cloud. In this case, the respective clusters may have different VM (Virtual Machine) specifications, and as a result, a scalable value may vary. For example, cloud available resource 5, cluster A VM spec 10->scalable: false or cloud available resource 5, cluster B VM spec 3->scalable: true may be represented. In general, a limit of the resource is not considered in a public cloud, but node scaling may be impossible due to user-specific resource limit (the maximum number of VMs and available resources).

The cluster API confirms again, and updates the scalable value when the available resource of the cloud is changed. Here, the available resource may be changed upon generation of a new cluster or node scaling.

The respective clusters may have different VM specifications, and as a result, the scalable value may vary, so a resource state may be represented for each cluster.

The resource state value is confirmed upon scheduling according to an embodiment of the disclosure, and when the node scaling is impossible, the pending is prevented in the corresponding cluster.

When a user preferentially intends to distribute the workload to a specific cluster in the logical cloud, a priority between clusters may be required. This is defined as a priority type.

There is a main cluster which becomes a main distribution target of the workload in the priority type of logical cloud, and when distribution to the main cluster is impossible, an auxiliary cluster is used.

In addition to the main cluster, a workload which is not distributed to a cluster having a relatively high priority is distributed to a cluster having a next priority.

To this end, the priority should be defined in all clusters which are present in the logical cloud.

In this case, the same priority may be applied between the clusters, and when the clusters have the same priority, the workload is randomly distributed to one cluster among the clusters having the same priority.

All clusters may become the main cluster or first to n-th auxiliary clusters in the logical cloud.

When there is the common cluster, the common cluster may also operate as the auxiliary cluster.

When there is the common cluster, the priority of the common cluster is set to be lower than the priority of a general cluster in the same cloud to use the general cluster earlier.

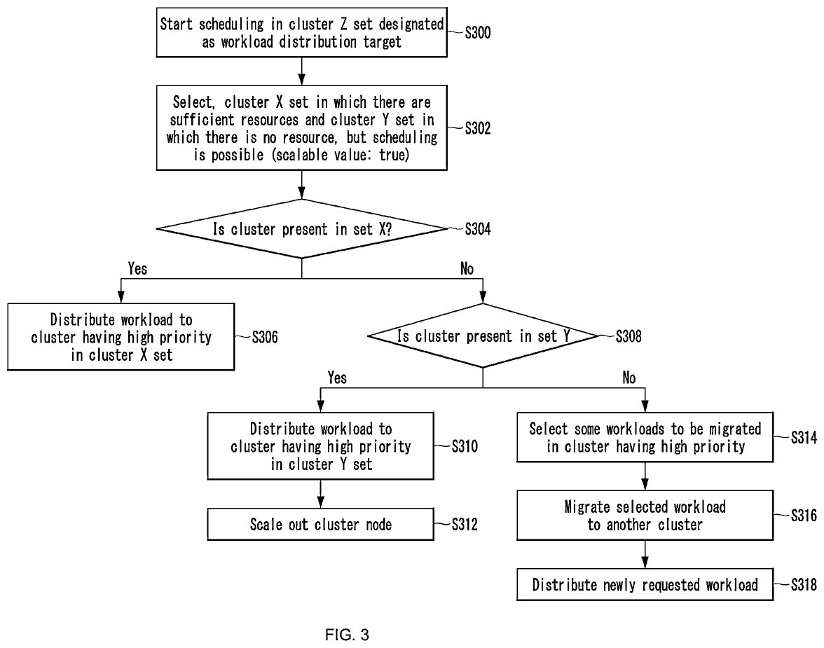

FIG. 3 is a diagram illustrating a node scaling process for a workload which is requested to be newly distributed according to an embodiment of the disclosure.

FIG. 3 is a diagram illustrating a process of selecting a cluster X set in which resources remain among a plurality of clusters which are designated as a distribution target of a workload and selecting a cluster Y set in which there is no resource, but node scaling is possible, and trying the distribution of the workload from the cluster X set to the cluster Y set.

Referring to FIG. 3, scheduling starts in a cluster Z set designated as a specific workload distribution target (step 300).

Thereafter, in the cluster Z set, the cluster X set in which there are sufficient resources and the cluster Y set in which there is no resource, but scheduling is possible (scalable value: true) are selected (step 302).

It is determined whether the cluster is present in set X (step 304), and when the cluster is present in set X, the workload is distributed to a cluster having a high priority in set X (step 306).

In step 306, when there are two or more clusters having the high priority, one of the clusters may be randomly selected to distribute the workload.

Meanwhile, in step 304, when there is no cluster in set X, it is determined whether there is a cluster in set Y (step 308), and when there is the cluster in set Y, the workload is distributed to the cluster having the high priority in set Y (step 310).

Even in step 310, when there are two or more clusters having the high priority, one of the clusters is randomly selected to distribute the workload.

In step 310, since there is no resource, but node scaling is possible in set Y, the distribution of the workload becomes a pending state.

After step 310, a process of scaling out a node of the corresponding cluster is performed (step 312).

In step 308, when there is no cluster in set Y, some workloads to be migrated are selected in a cluster having the high priority among the clusters in set Z (step 314), and the selected workload is migrated to another cluster (step 316).

Thereafter, a new requested workload is distributed (step 318).

As in FIG. 3, when a workload which is impossible to distribute is detected, a process of selecting the workload to be migrated, and migrating and deleting the selected workload is tried in order from the cluster X set to the cluster Y set, and then performed when there is no cluster in set Y.

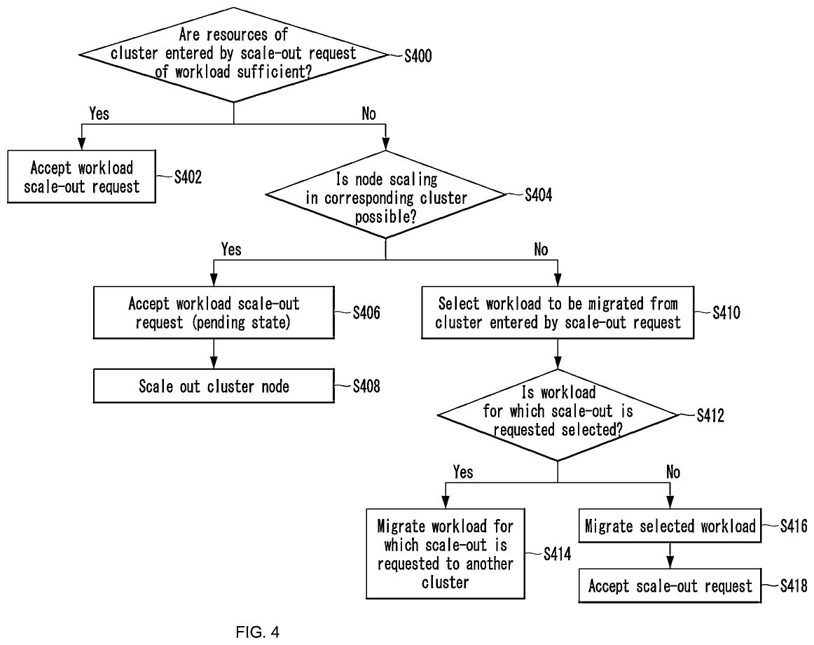

FIG. 4 is a diagram illustrating a processing process of a scale-out request of a workload in the related art.

Referring to FIG. 4, it is determined whether resources of a cluster which receives a scale-out request of a workload are sufficient (step 400).

When the resources are sufficient, the workload scale-out request is accepted (step 402).

In step 400, when the resources are not sufficient, it is determined whether node scaling of the corresponding cluster is possible (step 404).

When the node scaling is possible, the workload scale-out request is accepted (step 406).

Step 406 is in the pending state, and then node scale-out of the corresponding cluster is performed (step 408).

In step 404, when the node scaling is not possible, some workloads to be migrated are selected in the cluster which receives the scale-out request (step 410).

Next, it is determined whether the workload for which the scale-out is requested is selected (step 412), and when the workload is selected, the workload for which the scale-out is requested is migrated to another cluster (step 414).

Meanwhile, when the workload for which the scale-out is requested is not selected, that is, when the workload for which the scale-out is requested is not possible to migrate, another workload is selected, and the selected workload is migrated to another cluster (step 416), and the workload scale-out request is accepted (step 418).

Hereinafter, an intent for workload migration will be described.

The workload intent according to an embodiment of the disclosure may include whether migration is possible (migration) and priority information (priority).

Migration may be set to one of true and false values, and is set to false by default.

It is determined whether it is possible to migrate a specific workload to another cluster through the true/false value, and such a determination process may be performed by a migration controller.

In this case, a stateless workload may become a target set to true, that is, some workloads which are possible to migrate among the stateless workloads may be set to true. Even a workload in which migration is initially set to true is changed to false when there is only one cluster to which the corresponding workload may be distributed upon scheduling.

In addition, priority is a priority which is granted to the workloads which are possible to migrate to another cluster, and may have, for example, a value of 1 to 10, and may be set to 10 by default.

When the workload needs to be migrated, the workload having the high priority is first selected.

A policy for selecting the workload is set in a logical cloud for workload migration.

The policy according to an embodiment of the disclosure represents what is to be considered for better performance or which criterion among them is to be prioritized when selecting the workload to be migrated, and a rescheduling procedure varies in the logical cloud according to the policy.

That is, the policy according to an embodiment of the disclosure may include a plurality of criteria for rescheduling in the logical cloud and reflection priorities of the plurality of respective criteria.

Here, the criteria included in the policy may include a priority defined in the workload intent, an inter-service connectivity, and a CPU utilization.

For example, a workload having a high priority, a workload having a weak inter-service connectivity, and a workload having a small load defined in the workload intent may be selected as the workload to be migrated. The selection of the workload according to the inter-service connectivity may include preferentially selecting a standalone service.

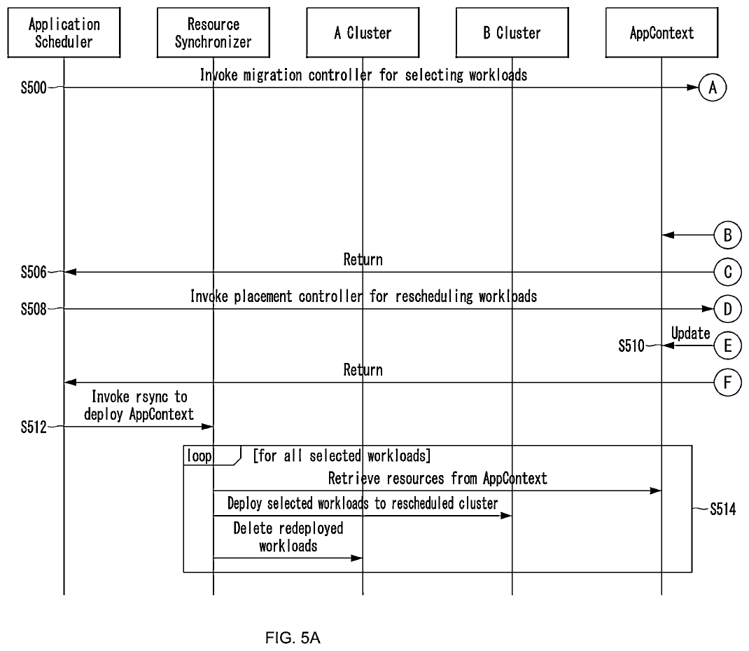

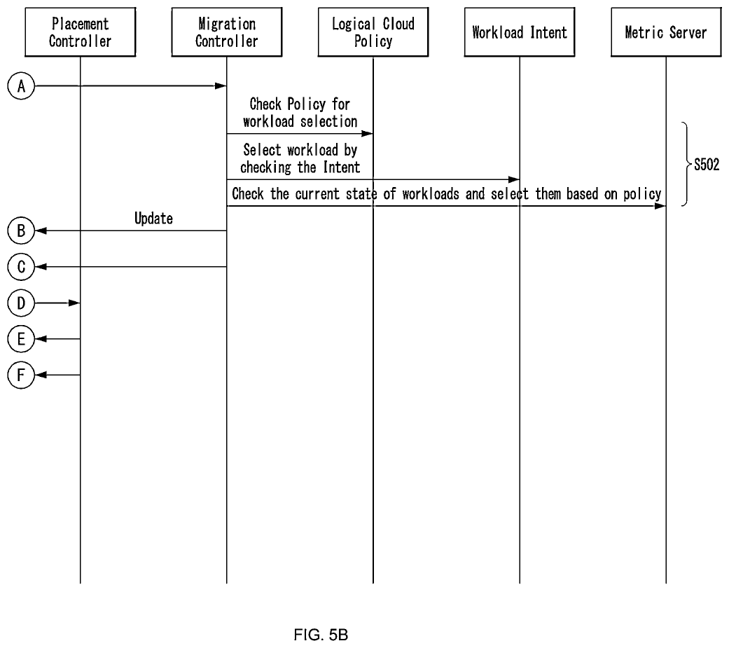

FIG. 5A to 5B are a flowchart illustrating a workload redistribution procedure according to an embodiment of the disclosure.

Referring to FIG. 5A to 5B, an application scheduler invokes a migration controller for selecting a workload to be migrated (step 500).

Step 500 is performed when a workload which is impossible to distribute due to lack of resources is detected in a logical cloud including a plurality of clusters which are present in multiple clouds.

The migration controller selects one or more first workloads to be migrated to another cluster from a first cluster by referring to a predetermined policy, and a workload intent set for workloads which are executed in the logical cloud (step 502).

In step 502, the migration controller may check a state of a workload in link with a metric server.

The migration controller selects one or more first workloads, and then updates AppContext (step 504), and transmits a response to selection of a workload to be migrated to the application scheduler (step 506).

The application scheduler invokes a placement controller (step 508), and the placement controller selects a second cluster to which one or more first workloads are to be migrated, and updates the AppContext (step 510).

Next, the application scheduler invokes a resource synchronizer (step 512), and the resource synchronizer performs a process of migrating the one or more first workloads to the second cluster by referring to the AppContext in which information on one or more first workloads and the second cluster is updated, and deleting the one or more first workloads from the first cluster (step 514).

Thereafter, a distribution process of a workload which is not distributed before the first cluster from which the workload is deleted is performed.

A process is performed, in which the service to be migrated may be distributed to the second cluster (cluster B), and then traffic entering the same service of the first cluster (cluster A) may be directed to the distributed service of cluster B, and an IP address mapped with URL is changed, and then the corresponding service is deleted from cluster A, and hereinafter, this will be described below again.

According to an embodiment of the disclosure, an Istio ingress gateway may be used so that migration is possible without service interruption.

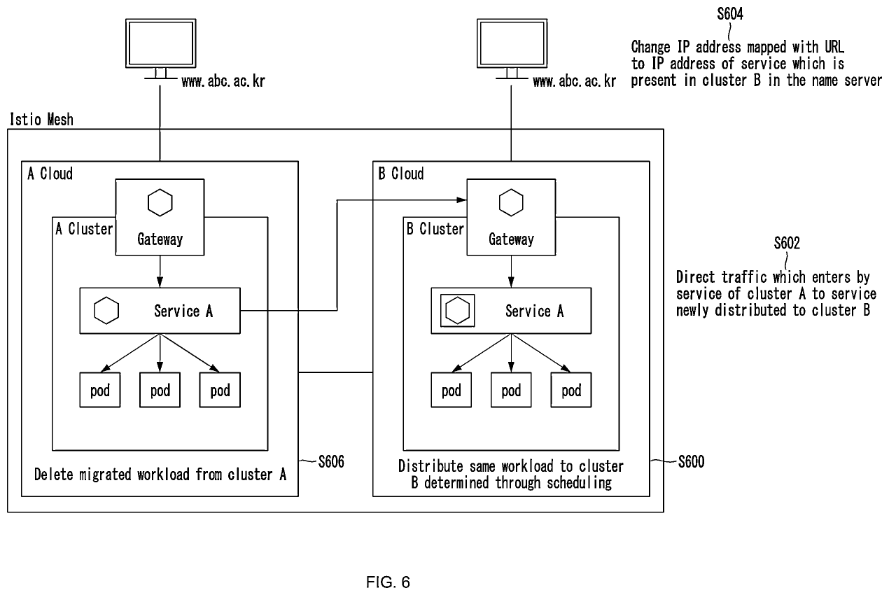

FIG. 6 is a diagram illustrating a service migration process using an Istio ingress gateway.

FIG. 6 is a diagram exemplarily illustrating a migration process of a standalone service.

Istio is defined as a service mesh which a modernized service networking layer providing a transparent language independent method which may flexibly and easily automate an application network function.

Referring to FIG. 6, the same workload is distributed to cluster B determined through scheduling (step 600), and Istio ingress gateway is used so that traffic entering by a service of cluster A may be directed to a service newly distributed to cluster B (step 602).

The distributed service is exposed through a gateway of the corresponding cluster, and information on the service distributed to cluster B should be updated through a control plane of cluster A in order to direct the traffic from cluster A to cluster B before updating domain name system (DNS) (step 604).

When all tasks which are being processed in cluster A are completed, the service may be continued without interruption by updating the DNS.

Last, a migrated workload is deleted from cluster A (step 606).

An assumption when Istio is used in a multi-cloud environment is as follows.

The Istio control plane should be installed in each cluster, and all services entered from the outside of a specific cluster pass through an ingress gateway of the corresponding cluster.

When the service is distributed from cluster A to cluster B, a proxy for the corresponding service should also be jointly prepared, and may be automated through automatic sidecar injection.

Embodiments of the present disclosure are disclosed for the purpose of exemplification and those skilled in the art will be able to make various modifications, changes, and additions within the spirit and scope of the present disclosure, and such modifications, changes, and additions should be considered as falling within the scope of the following claims.

What is claimed is:

1. A method for managing Kubernetes cluster resources in a multi-cloud environment, the method comprising:
(a) selecting, when a workload which is impossible to distribute due to lack of resources is detected in a logical cloud including a plurality of clusters which are present in multiple clouds, one or more first workloads to be migrated from a first cluster to another cluster by referring to a predetermined policy, and a workload intent set for workloads executed in the logical cloud;
(b) selecting a second cluster to which the one or more first workloads are to be migrated;
(c) migrating the one or more first workloads to the second cluster, and deleting the one or more first workloads from the first cluster; and
(d) distributing the workload which is impossible to distribute to the first cluster.

2. The method of claim 1, further comprising:
before step (a) above,
configuring one or more logical clouds including the plurality of clusters through a management cluster; and
monitoring a resource of each of the plurality of clusters through a cluster application programming interface (API).

3. The method of claim 1, wherein step (a) above includes:
invoking, by an application scheduler, a migration controller when the workload which is impossible to distribute is detected;
selecting, by the migration controller, one or more first workloads to be migrated to another cluster by referring to the policy and the workload intent; and
selecting, by a placement controller, the second cluster to which the one or more first workloads are to be migrated according to the invoking by the application scheduler.

4. The method of claim 2, wherein the cluster API stores information on whether node scaling is possible in each of the plurality of clusters.

5. The method of claim 4, comprising:
before step (a) above,
selecting a cluster X set in which resources remain and a cluster Y set in which there is no resource, but the node scaling is possible among a plurality of clusters designated as a distribution target of the workload; and
trying the distribution of the workload in order from the cluster X set to the cluster Y set.

6. The method of claim 5, wherein steps (a) to (d) above are performed when the workload distribution is unsuccessful in both the cluster X set and the cluster Y set.

7. The method of claim 1, wherein when there is a scale-out request of an application which is being currently executed, steps (a) to (d) above are performed when resources of the clusters receiving the scale-out request are insufficient, and node scaling in the clusters receiving the scale-out request is impossible.

8. The method of claim 1, wherein the workload intent includes whether it is possible to migrate each workload and priority information.

9. The method of claim 8, wherein the policy includes a plurality of criteria for rescheduling in the logical cloud and reflection rankings of the plurality of respective criteria.

10. The method of claim 9, wherein the plurality of criteria includes a priority defined in the workload intent, an inter-service connectivity, and a central processing unit (CPU) utilization.

11. The method of claim 1, wherein the first cluster and the second cluster are included in different clouds.

12. The method of claim 11, wherein step (c) above includes:
between the migrating of the one or more first workloads to the second cluster and the deleting of the one or more first workloads from the first cluster,
changing an internet protocol (IP) address mapped with a uniform resource locator (URL) of an initial service to an IP address of a service which is present in the second cluster in a name server; and
transmitting traffic input from a first Istio ingress gateway included in the first cluster to a second Istio ingress gateway included in the second cluster.

13. A system for managing a cluster resource in multiple clouds, the system comprising:
an application scheduler detecting a workload which is impossible to distribute due to lack of resources in a logical cloud including a plurality of clusters which are present in the multiple clouds;
a migration controller selecting one or more first workloads to be migrated to another cluster from a first cluster by referring to a predetermined policy, and a workload intent set for workloads which are executed in the logical cloud, by an invoking by the application scheduler;
a placement controller selecting a second cluster to which the one or more first workloads are to be migrated according to the invoking by the application scheduler; and
a resource synchronizer migrating the one or more first workloads to the second cluster by referring to AppContext in which information on the one or more first workloads and the second cluster is updated, deleting the one or more first workloads from the first cluster, and distributing the workload which is impossible to distribute to the first cluster after the one or more first workloads are deleted.

14. The system of claim 13, wherein the application scheduler, the migration controller, the placement controller, and the resource synchronizer are managed through a management cluster, and
the management cluster further includes a cluster API configuring one or more logical clouds including a plurality of clusters, and monitoring resources of the plurality of respective clusters.

15. An apparatus for managing a cluster resource in multiple clouds, the apparatus comprising:
a processor; and
a memory connected to the processor,
wherein the memory stores program instructions executed by the processor to
select, when a workload which is impossible to distribute due to lack of resources is detected in a logical cloud including a plurality of clusters which are present in multiple clouds, one or more first workloads to be migrated from a first cluster to another cluster by referring to a predetermined policy, and a workload intent set for workloads executed in the logical cloud,
select a second cluster to which the one or more first workloads are to be migrated,
migrate the one or more first workloads to the second cluster,
delete the one or more first workloads from the first cluster, and
distribute the workload which is impossible to distribute to the first cluster after the one or more first workloads are deleted.
